(19) United States
(12) Patent Application Publication
(10) Pub. No.: US 2024/0281868 A1
(43) Pub. Date: Aug. 22, 2024

(54) INFORMATION PROCESSING SYSTEM, INFORMATION PROCESSING APPARATUS, AND INFORMATION PROCESSING METHOD

(71) Applicant: TOSHIBA TEC KABUSHIKI KAISHA, Tokyo (JP)

(72) Inventors: Yoshinori Iwase, Noda Chiba (JP); Yu Saito, Fujisawa Kanagawa (JP); Atsushi Nakanishi, Chofu Tokyo (JP)

(21) Appl. No.: 18/544,478

(22) Filed: Dec. 19, 2023

(30) Foreign Application Priority Data
Feb. 22, 2023 (JP) 2023-026145

(51) Int. Cl. G06Q 30/0601; G06Q 10/083; G06Q 10/087

(52) U.S. Cl. CPC G06Q 30/0637; G06Q 10/083; G06Q 10/087

(57) ABSTRACT

An information processing system according to an embodiment includes a management server, a plurality of store servers, and a store terminal. The management server receives order data including information for specifying an ordered commodity and a store from an external management server that aggregates an order from a customer who requests delivery of a commodity in stock at a store from the store. The store servers are provided in a plurality of stores, respectively, and each communicate with the management server. The store terminal communicates with any store server among the plurality of store servers. The management server transmits the received order data to a store server of the store specified by the order data among the store servers. Each store server receives registration of a commodity performed by the store terminal for each transaction in a host store, and notifies a user that a delivery order is placed in at least one of the store server and the store terminal when receiving the order data.

### CROSS-REFERENCE TO RELATED APPLICATION

This application is based upon and claims the benefit of priority from Japanese Patent Application No. 2023-026145, filed Feb. 22, 2023, the entire contents of which are incorporated herein by reference.

### FIELD

Embodiments described herein relate to an information processing system, an information processing apparatus, and an information processing method.

### BACKGROUND

In the related art, there is known a technique related to a mobile order service in which a customer can order a commodity and perform a settlement by using a mobile terminal such as a smartphone or a tablet terminal of the customer. For example, there is an order linkage system that links an order received by the mobile order service with an order received by a terminal of a store.

For example, order data of the customer received by a delivery business operator is provided to a store corresponding to the mobile order service. However, in a store such as a convenience store, a customer who visits the store can also purchase the commodity. Therefore, it is necessary for a store clerk to separately check the order data from the delivery business operator in addition to normal work in the store, and a delivery order from the delivery business operator may be overlooked. In addition, when the delivery order is overlooked, delivery of the commodity to the delivery business operator may be delayed, or there may be a shortage of a commodity for the delivery order due to a customer visiting the store and purchasing the commodity.

### DESCRIPTION OF THE DRAWINGS

FIG. 1 is a diagram illustrating an example of a configuration of an order linkage system according to an embodiment;

FIG. 2 is a block diagram illustrating an example of a configuration of a management server;

FIG. 3 is a block diagram illustrating an example of a configuration of a store server;

FIG. 4 is a sequence diagram illustrating an example of a flow of processing to be executed;

FIG. 5 is a diagram illustrating an example of a displayed screen;

FIG. 6 is a diagram illustrating an example of a displayed screen; and

FIG. 7 is a diagram illustrating an example of a displayed screen.

### DETAILED DESCRIPTION

In general, according to one embodiment, overlooking a delivery order in a store is reduced.

An information processing system according to an embodiment includes a management server, a plurality of store servers, and a store terminal. The management server receives order data including information for specifying an ordered commodity and a store from an external management server that aggregates an order from a customer who requests delivery of a commodity in stock at a store from the store. The plurality of store servers are provided in a plurality of stores, respectively, and each communicate with the management server. The store terminal communicates with any store server among the plurality of store servers. The management server transmits the received order data to a store server of the store specified by the order data among the plurality of store servers. Each of the plurality of store servers receives registration of a commodity performed by the store terminal for each transaction in a host store, and notifies a user that a delivery order is placed in at least one of the store server and the store terminal when receiving the order data.

Hereinafter, an information processing apparatus, an information processing system, a method and a program according to the embodiment will be described with reference to the drawings.

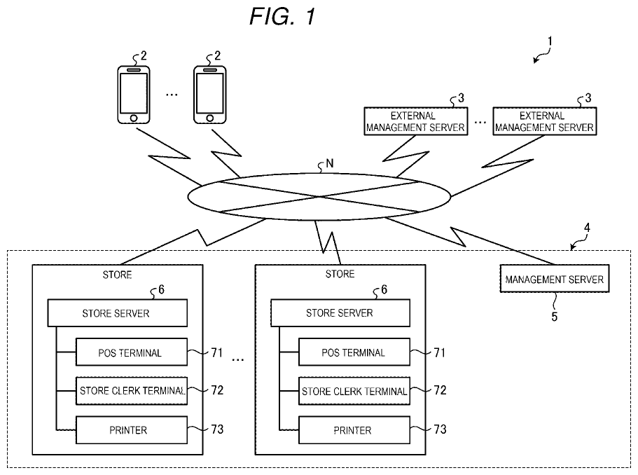

FIG. 1 is a diagram illustrating an example of a configuration of an order linkage system 1 according to the embodiment.

The order linkage system 1 according to the present embodiment links a customer order in an external service such as a delivery service provided by a delivery business operator with a POS or an order entry system (OES) of a store. The order linkage system 1 is constructed across a business operator (store) that operates the store, a customer who uses the store, the delivery business operator that provides the delivery service related to a commodity of the store to the customer, and a linkage service business operator that provides an order linkage service for linking a store operation and the delivery service. The delivery business operator receives an order for a commodity in stock at the store from the customer, places the order to the store that sells the commodity via the linkage service business operator, and performs a settlement related to the order and delivery from the store having the ordered commodity to the customer.

The order linkage system 1 includes at least one customer terminal 2, at least one external management server 3, and an order management system 4. The order management system 4 includes at least one management server 5, at least one store server 6, at least one POS terminal 71, at least one store clerk terminal 72, and at least one printer 73.

The number of the customer terminals 2, the external management servers 3, the management servers 5, the store servers 6, the POS terminals 71, the store clerk terminals 72, and the printers 73 is not limited to the example illustrated in the drawing.

The customer terminal 2 and the external management server 3 are communicably connected via a network N such as the Internet. The management server 5 is communicably connected to the external management server 3, the store server 6, and the store clerk terminal 72 via the network N. Further, the store server 6 is communicably connected to the point of sales (POS) terminal 71, the store clerk terminal 72, and the printer 73 via a network such as a local area network (LAN) in the store.

Here, the order linkage system 1 or the order management system 4 according to the embodiment is an example of the information processing system. The management server 5 or the store server 6 according to the embodiment is an example of the information processing apparatus. Further, the store server 6, the POS terminal 71, or the store clerk terminal 72 according to the embodiment are an example of the store terminal.

In addition to the store server 6, the POS terminal 71, and the store clerk terminal 72, the store terminal may include a digital signage terminal for displaying predetermined content, information, and the like provided in the store, an electronic shelf label terminal for displaying a price of a commodity, a commodity name, information on the commodity, and the like. In this case, the digital signage terminal and the electronic shelf label terminal can function as notification destinations to which display information is output.

The customer terminal 2 is an information processing terminal operated by the customer who uses the delivery service. As the customer terminal 2, a smartphone, a tablet terminal, and the like can be used as appropriate. The customer terminal 2 transmits and receives information to and from the external management server 3. The customer terminal 2 transmits and receives the information to and from the external management server 3 by using, for example, a function of an application provided by a business operator of the delivery service or a web browser. The customer can order delivery of the commodity in the store by using the customer terminal 2. Accordingly, the customer can receive the ordered commodity.

The external management server 3 is a server device managed by the delivery service business operator. The external management server 3 stores, for example, a member master in which an ID, a name, a notification destination, settlement information, and the like of a member of the delivery service are registered in association with one another. The external management server 3 stores data of order information (hereinafter, referred to as order data) received from the customer terminal 2 of the member of the delivery service in association with the member ID. For example, the order data includes at least a code for specifying a store where an order is placed and a code for specifying a commodity to be ordered. The order data received by the external management server 3 is transmitted to the store server 6 via the management server 5. When receiving a settlement request from the customer terminal 2, the external management server 3 transmits and receives information to and from a settlement server (not illustrated) of a settlement business operator to complete a settlement related to the order of the customer. For example, the external management server 3 aggregates the order from the customer who requests the delivery of the commodity in stock at the store from the store.

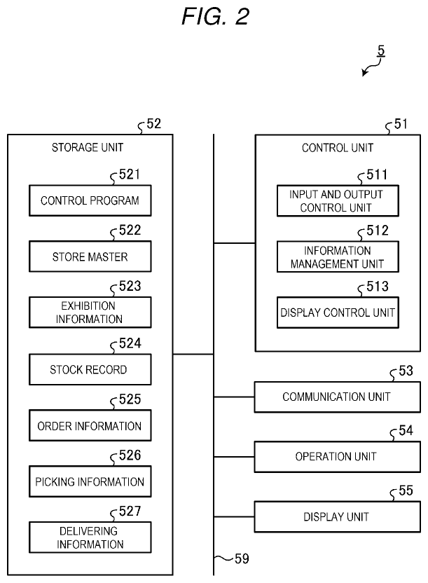

The management server 5 is a server device managed by the linkage service business operator. For example, the management server 5 receives the order data including the information for specifying the ordered commodity and the store from the external management server 3. For example, the management server 5 transmits the received order data to the store server 6 of the store among the plurality of store servers 6, which is specified by the order data. Details of the management server 5 will be described later (see FIG. 2).

The management server 5 may be capable of implementing a part or all of functions of the external management server 3. Further, the management server 5 may be capable of implementing a part or all of functions of the store server 6.

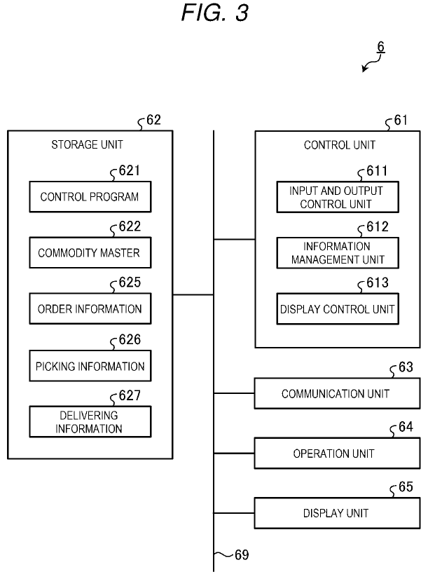

The store server 6 is a server device managed by a store that sells an ordered commodity. The store server 6 may be a store computer or a store controller. For example, the store server 6 is provided in each of the plurality of stores and communicates with the management server 5. For example, the store server 6 receives the registration of the commodity performed by the POS terminal 71 for each transaction in the host store. For example, when receiving the order data from the management server 5, the store server 6 notifies, by at least one of the host device, the POS terminal 71, the store clerk terminal 72, and the printer 73, the user that the delivery order is placed. Details of the store server 6 will be described later (see FIG. 3).

The store server 5 may be capable of implementing a part or all of functions of the management server 6. The store server 6 may be capable of implementing a part or all of functions of the POS terminal 71. The store server 6 may be capable of implementing a part or all of functions of the store clerk terminal 72. Further, the store server 6 may be configured integrally with the printer 73 mounted thereon.

The POS terminal 71 is, for example, an information processing terminal provided in the store. For example, the POS terminal 71 communicates with the store server 6. The POS terminal 71 executes commodity registration processing and checkout processing for each transaction for the customer who visits the store. The POS terminal 71 may be capable of implementing a part or all of the functions of the store server 6. The POS terminal 71 may be capable of implementing a part or all of the functions of the store clerk terminal 72. Further, the POS terminal 71 may be configured integrally with the printer 73 mounted thereon.

The store clerk terminal 72 is, for example, an information device carried by the store clerk in the store. For example, the store clerk terminal 72 communicates with the management server 5 and the store server 6. The store clerk terminal 72 may be capable of implementing a part or all of the functions of the store server 6. For example, the store clerk terminal 72 may be integrated with the store server 6. The store clerk terminal 72 may be capable of implementing a part or all of the functions of the POS terminal 71. For example, the store clerk terminal 72 may be integrated with the POS terminal 71. Further, the store clerk terminal 72 may be configured integrally with the printer 73 mounted thereon.

The printer 73 is provided, for example, in the store. The printer 73 issues a slip on which delivering information including information on the ordered commodity is printed. The printer 73 may issue a slip on which picking information to be described later is printed.

Here, a hardware configuration of the management server 5 will be described with reference to the drawings. FIG. 2 is a block diagram illustrating an example of a configuration of the management server 5 according to the embodiment.

The management server 5 includes a control unit 51, a storage unit 52, a communication unit 53, an operation unit 54, and a display unit 55. The control unit 51, the storage unit 52, the communication unit 53, the operation unit 54, and the display unit 55 are connected to one another via a bus 59.

The control unit 51 includes a central processing unit (CPU), a read only memory (ROM), and a random access memory (RAM). The CPU, the ROM, and the RAM are communicably connected via an internal bus. The control unit 51 is configured similarly to, for example, a general computer, and controls an operation of each unit of the management server 5 by loading various programs stored in the ROM and the storage unit 52 into the RAM and causing the CPU to execute the loaded various programs.

The CPU of the control unit 51 according to the embodiment is an example of a processor in the management server 5. As the processor, another processor may be provided instead of or in addition to the CPU. As another processor, various processors such as a graphic processing unit (GPU) and a digital signal processor (DSP), a dedicated arithmetic circuit implemented by an application specific integrated circuit (ASIC) and a field programmable gate array (FPGA), and the like can be used as appropriate.

The storage unit 52 is a storage device including a non-volatile storage medium such as a hard disk drive (HDD) and a solid state drive (SSD). The storage unit 52 stores various programs and various types of data related to an operation of the management server 5. For example, the storage unit 52 stores a control program 521, a store master 522, exhibition information 523, a stock record 524, order information 525, picking information 526, and delivering information 527.

The control program 521 is a program for operating the management server 5.

The store master 522 is a master file for managing information on the plurality of stores in the order management system 4. For example, the store master 522 stores a store name and a notification destination in association with a store ID. The store ID is information for identifying a store. The store name is information indicating a name of the store. The notification destination is information indicating the notification destination of the store such as a communication address of the store server 6 and the store clerk terminal 72 and a telephone number of the store.

The exhibition information 523 is information indicating a position of each commodity in each of the plurality of stores in the order management system 4. For example, the exhibition information 523 includes information of a commodity code (for example, JAN), a gondola number, a shelf position, a stage, a row, and the number of faces.

The stock record 524 is information indicating stock of each commodity in each of the plurality of stores in the order management system 4. For example, the stock record 524 includes information of the commodity code (for example, JAN), the number of items in stock, and an out-of-stock flag.

The order information 525 is information on a delivery order of each of the plurality of stores in the order management system 4. For example, the order information 525 includes information of a delivery number, the commodity code (for example, JAN), the number, and a unit price.

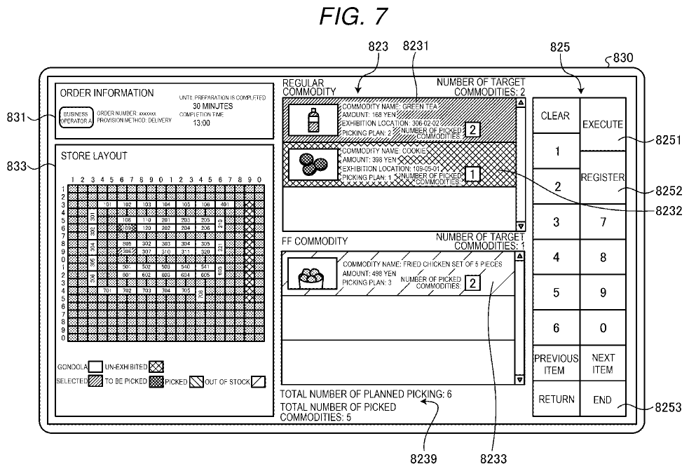

The picking information 526 is picking information 626 for each delivery order for each of the plurality of stores in the order management system 4 and is information including at least a position and the number of the commodities in the store. Information on the position of the commodity in the store includes, for example, a store layout image 833 (see FIG. 7) and a gondola position information image. The gondola position information image is information indicating a position of a commodity on a gondola and can be displayed, for example, when a target gondola is selected in the store layout image 833. The gondola position information image includes, for example, information for specifying the commodity position in the gondola such as the gondola number, the shelf position, the stage, the row, and a face.

The delivering information 527 is delivering information 627 for each delivery order for each of the plurality of stores in the order management system 4.

The communication unit 53 is a communication interface for communicating with an outside of the management server 5 via the network N. The communication unit 53 is configured to transmit and receive information (data) to and from an external device under the control of the control unit 51.

The operation unit 54 is an input interface for receiving an operation input from the user. As the operation unit 54, various input devices such as a keyboard, a touch panel, and a mouse can be used as appropriate.

The display unit 55 is configured to display a generated screen under the control of the control unit 51. As the display unit 55, various display devices such as a liquid crystal display (LCD) and an organic electro-luminescence (EL) display can be used as appropriate.

Here, a functional configuration of the management server 5 will be described with reference to FIG. 2.

The control unit 51 executes the control program 521 loaded into the RAM, thereby functioning as an input and output control unit 511, an information management unit 512, and a display control unit 513 as illustrated in FIG. 2.

The input and output control unit 511 controls input and output of various types of information in the management server 5. Here, the input and output control unit 511 according to the embodiment is an example of an acquisition unit and an output unit.

For example, the input and output control unit 511 acquires, from the external management server 3, the order data that is related to the order from the customer who requests the delivery of the commodity in stock at the store from the store and that includes the information for specifying the ordered commodity and the store. For example, the input and output control unit 511 outputs the order data including the information for specifying the ordered commodity to the store server 6 of a target store.

For example, the input and output control unit 511 acquires, from the store server 6, out-of-stock information that is based on the stock record 524 and that indicates a commodity handled as out-of-stock in the delivery order. For example, the input and output control unit 511 outputs the out-of-stock information to the external management server 3.

Further, for example, the input and output control unit 511 outputs the out-of-stock information that is based on the stock record 524 to the customer terminal 2. When receiving the out-of-stock information, the customer terminal 2 displays that the commodity is out of stock on a display unit (not illustrated) of the customer terminal 2. Alternatively, the input and output control unit 511 outputs, to the customer terminal 2, information for causing the customer terminal 2 to hide the out-of-stock commodity. When receiving the information, the customer terminal 2 hides the commodity on the display unit of the customer terminal 2. Further, when a predetermined commodity becomes in stock from an out-of-stock state and is no longer in the out-of-stock state, the input and output control unit 511 may output, to the customer terminal 2, information for deleting the out-of-stock display or information for displaying the commodity that is hidden because the commodity is out of stock.

The information management unit 512 controls updating and recording of various types of information in the management server 5.

For example, the information management unit 512 updates the stock record 524 when picking registration for each piece of order data s completed or when sales registration for one transaction in the store is completed.

The display control unit 513 controls a display of various types of information in the management server 5 by the display unit 55. The display control unit 513 may generate display information for display not only on the display unit 55 but also on each device of the order management system 4.

Here, a hardware configuration of the store server 6 will be described with reference to the drawings. FIG. 3 is a block diagram illustrating an example of a configuration of the store server 6 according to the embodiment.

The store server 6 includes a control unit 61, a storage unit 62, a communication unit 63, an operation unit 64, and a display unit 65. The control unit 61, the storage unit 62, the communication unit 63, the operation unit 64, and the display unit 65 are connected via a bus 69.

The control unit 61 includes a CPU, a ROM, and a RAM. The CPU, the ROM, and the RAM are communicably connected via an internal bus. The control unit 61 is configured similarly to, for example, a general computer, and controls an operation of each unit of the store server 6 by loading various programs stored in the ROM and the storage unit 62 into the RAM and causing the CPU to execute the loaded various programs.

The CPU of the control unit 61 according to the embodiment is an example of a processor in the store server 6. As the processor, another processor may be provided instead of or in addition to the CPU. As another processor, various processors such as a GPU and a DSP, a dedicated arithmetic circuit implemented by an ASIC and an FPGA, and the like can be used as appropriate.

The storage unit 62 is a storage device including a non-volatile storage medium such as an HDD and an SSD. The storage unit 62 stores various programs and various types of data related to an operation of the store server 6. For example, the storage unit 62 stores a control program 621, a commodity master 622, order information 625, the picking information 626, and the delivering information 627.

The control program 621 is a program for operating the store server 6.

The commodity master 622 is a master file for managing commodity information on the commodity sold in the store. For example, the commodity master 622 stores the commodity name and the unit price in association with a commodity ID. The commodity ID is information for specifying the commodity. The commodity name is information indicating the name of the commodity. The unit price is information indicating a price per sales unit of the commodity. The commodity master 622 may store other commodity information such as a commodity image. The commodity master 622 according to the present embodiment is common to, for example, store sales and the delivery order.

The order information 625 is information on a delivery order at the host store. For example, the order information 625 includes information of a delivery number, the commodity code (for example, JAN), the number, and a unit price.

The picking information 626 is information for picking work for each delivery order in the host store. For example, the picking information 626 is information including at least the position and the number of the commodities in the host store.

The delivering information 627 is information for each delivery order in the host store. For example, the delivering information 627 includes information such as an order reception time and a delivery time of the delivery order, a delivery business operator name, a slip number, the commodity name, and the number.

The communication unit 63 is a communication interface for communicating with an outside of the store server 6 via the network N. The communication unit 63 is configured to transmit and receive information (data) to and from an external device under the control of the control unit 61.

The operation unit 64 is an input interface for receiving an operation input from the user. As the operation unit 64, various input devices such as a keyboard, a touch panel, and a mouse can be used as appropriate.

The display unit 65 is configured to display a generated screen under the control of the control unit 61. As the display unit 65, various display devices such as a liquid crystal display and an organic EL display can be used as appropriate.

Here, a functional configuration of the store server 6 will be described with reference to FIG. 3.

The control unit 61 executes the control program 621 loaded into the RAM, thereby functioning as an input and output control unit 611, an information management unit 612, and a display control unit 613 as illustrated in FIG. 3.

The input and output control unit 611 controls input and output of various types of information in the store server 6. Here, the input and output control unit 611 according to the embodiment is an example of the acquisition unit and the output unit.

For example, the input and output control unit 611 acquires, from the management server 5, the order data that is related to the order from the customer who requests the delivery of the commodity in stock at the store from the store and that includes the information for specifying the ordered commodity.

For example, after the picking registration for each piece of order data is completed, the input and output control unit 611 outputs, to the printer 73, printing information for outputting a slip to be attached to a commodity to be picked for each piece of order data.

For example, the input and output control unit 611 outputs, to the management server 5, the out-of-stock information that is based on the stock record 524 and indicates the commodity handled as out-of-stock in the delivery order. The out-of-stock information may include a commodity code indicating a commodity whose number in the stock record 524 is less than a predetermined stock threshold. The stock threshold is predetermined and stored in the storage unit 62. The stock threshold may be set based on an update frequency of the stock record 524. For example, the lower the update frequency is, that is, the longer an update time interval is, the larger the stock threshold may be set. In this case, by setting the stock threshold to be large even when the update frequency is low, notification of the out-of-stock information can be performed at an appropriate timing. In addition, for example, the higher the update frequency associated with the store sales is, the less the stock threshold may be set. In this case, by setting the stock threshold to be small even when the update frequency is high, notification of the out-of-stock information can be performed at an appropriate timing since a frequency of the out-of-stock information notification is reduced.

Further, for example, the higher the update frequency is, that is, the shorter the update time interval is, the smaller the stock threshold may be set. In this case, by setting the stock threshold to be small even when the update frequency is high, notification of the out-of-stock information can be performed at an appropriate timing since the frequency of the out-of-stock information notification is reduced. In addition, for example, the lower the update frequency associated with the store sales is, the larger the stock threshold may be set. In this case, by setting the stock threshold to be large even when the update frequency is low, notification of the out-of-stock information can be performed at an appropriate timing since notification of the out-of-stock information is performed at a timing at which the commodity is actually out of stock.

The information management unit 612 controls updating and recording of various types of information in the store server 6.

For example, the information management unit 612 receives registration of the commodity for each transaction in the host store and registration of the picked commodity for each piece of order data of the delivery order. For example, the information management unit 612 receives these pieces of registration by using the common commodity master 622.

For example, the information management unit 612 automatically records store sales based on a registration result of the picked commodity for each piece of order data after the picking registration for each piece of order data is completed.

For example, the information management unit 612 specifies a commodity whose number in the stock record 524 is less than the stock threshold as a commodity which is an output target of the out-of-stock information.

The display control unit 613 controls a display of various types of information in the store server 6 by the display unit 65. The display control unit 613 may generate display information for display not only on the display unit 65, but also on each device in the store.

For example, when the order data is acquired from the management server 5, the display control unit 613 notifies the user that the delivery order is placed. For example, the display control unit 613 ends the notification when the registration of the picked commodity for each piece of order data is completed.

For example, when the order data is acquired from the management server 5, the display control unit 613 generates, based on the order data, exhibition information indicating an arrangement of the commodity in the host store, and the stock record 524 indicating the stock of the commodity in the host store, picking data for displaying commodity information, the number, and an arrangement for the commodity to be picked for each piece of order data.

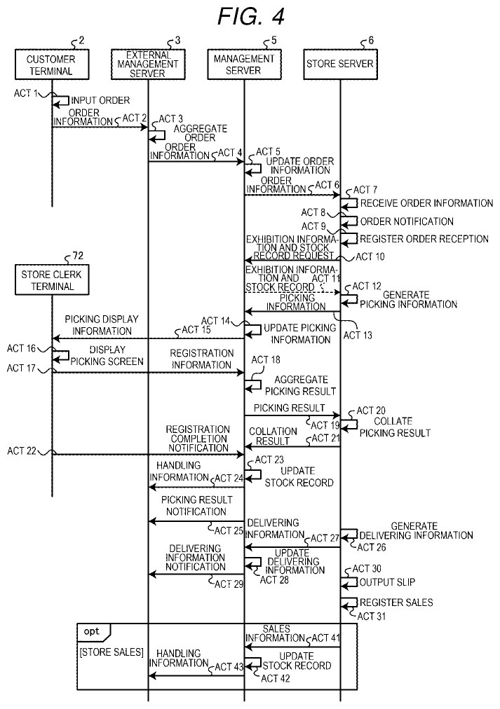

An operation example of the order linkage system 1 having the described above configuration will be described. FIG. 4 is a sequence diagram illustrating an example of a flow of processing executed in the order linkage system 1 according to the embodiment.

The customer uses the customer terminal 2 to input an order for requesting the delivery of the commodity in stock at the store from the store (ACT 1). The customer terminal 2 outputs the data of the order information (order data) to the external management server 3 (ACT 2).

The external management server 3 acquires and aggregates the order data of the customer from the customer terminal 2 (ACT 3). The external management server 3 outputs each piece of the aggregated order data to the management server 5 in the order management system 4 which provides the corresponding order linkage service (ACT 4).

The management server 5 acquires the order data from the external management server 3, aggregates the order data, and updates the order information 525 (ACT 5). The management server 5 outputs each piece of the aggregated order data to the store server 6 of the corresponding store (ACT 6).

The store server 6 receives the order data from the management server 5 and stores the order data as the order information 625 (ACT 7). The store server 6 may acquire the order data, for example, by receiving the order data from the management server 5 at a predetermined cycle or timing, and for example, may acquire the order data by receiving the order data push-transmitted by the management server 5.

In this way, when the customer completes the delivery order, the delivery order is linked from the external management server 3 of the delivery business operator to the order management system 4, and further, the order data is linked to the external management server 3, the management server 5, and the store server 6.

When acquiring the order data from the management server 5, the store server 6 performs order notification for notifying that the delivery order is placed, and notifies the user (store clerk) that the delivery order is placed (ACT 8). The store server 6 may perform the notification by displaying a notification screen on the display unit 65. The store server 6 may perform the notification by outputting the display information to cause a display (not illustrated) of the POS terminal 71 or the store clerk terminal 72 to display the notification screen. In addition, the store server 6 may perform the notification by outputting the printing information to cause the printer 73 to issue the slip on which the order information (order notification) is printed.

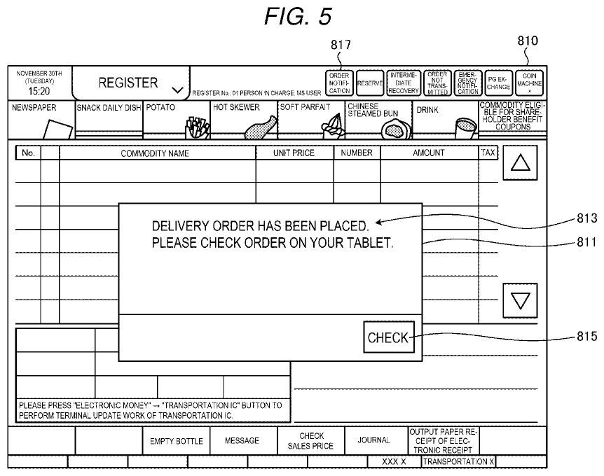

FIG. 5 is a diagram illustrating an example of a screen 810 displayed in the processing of FIG. 4. FIG. 5 illustrates a case where the display information is output from the store server 6 and the order notification screen 810 is displayed on the display (not illustrated) of the POS terminal 71. FIG. 5 illustrates that a pop-up display 811 is displayed on a commodity registration screen in an overlapping way in the POS terminal 71. Here, the commodity registration screen is an example of a screen on which a commodity purchased by the customer can be registered. The commodity registration screen displays, for example, preset keys for registering the commodity such as “newspaper”, “snack daily dish”, “potato”, “hot skewer”, “soft parfait”, “Chinese steamed bun”, “drink”, and “commodity eligible for shareholder benefit coupons”. The commodity registration screen may include a detail display area for displaying information such as “commodity name”, “unit price”, “number”, “amount”, and “tax category” of the commodity registered by an operation of the store clerk on the preset key or reading of a bar code attached to the commodity. The detail display area does not always need to display the information of “commodity name”, “unit price”, “number”, “amount”, and “tax category”, and it is sufficient to display any of these pieces of information. The commodity registration screen may be further provided with an “empty bottle” key for registering an empty bottle, or may be provided with a “check sales price” key for checking a sales price, a “journal” key for checking journal data indicating a log of transactions, and an “output paper receipt of electronic receipt” key for issuing a paper receipt to a customer who desires a paper receipt output instead of an electronic receipt.

The screen 810 of FIG. 5 includes the pop-up display 811 of the order notification. The pop-up display 811 includes a message 813 such as “Delivery order is placed. Please check order on your tablet.” In FIG. 5, the POS terminal 71 displays the pop-up display 811 of the order notification on the commodity registration screen in an overlapping way. Accordingly, the store clerk can be prevented from overlooking the delivery order by popping up the order notification in the store clerk terminal 72. In this way, the store clerk can be prevented from overlooking the delivery order by popping up the order notification not only on a terminal dedicated to the delivery order, but also on the store server 6, the POS terminal 71, and the store clerk terminal 72 used by the store clerk in other work related to the delivery order in the store.

The pop-up display 811 further includes a display of a check button 815 for inputting a check of the order notification by the store clerk. In this way, by hiding the pop-up of the order notification after the store clerk checks the notification, the store clerk can be further prevented from overlooking the delivery order.

The screen 810 of FIG. 5 further includes a display of an indicator 817 of “order notification”. For example, the indicator 817 is turned on when the delivery order is placed in the store and is turned off when picking registration of all delivery orders is completed. That is, by turning on the indicator 817, it is possible to notify the store clerk that the picking registration is not completed for at least one delivery order. Accordingly, the store clerk can be further prevented from overlooking the delivery order. In this case, since the pop-up display 811 is not displayed on the commodity registration screen in an overlapping way (in other words, the indicator 817 is displayed in an area different from the detail display area in which registered “commodity name”, “unit price”, “number”, “amount”, “tax category”, and the like are displayed), the POS terminal 71 can notify the store clerk that the picking registration is not completed for at least one delivery order without interfering with commodity registration work operated by the store clerk.

The store server 6 may not perform the pop-up display 811, for example, when the store clerk registers the commodity for each transaction related to the customer who visits the host store with the POS terminal 71, or when the store clerk registers the picked commodity for each piece of order data with the store clerk terminal 72. On the other hand, the indicator 817 is turned on when the delivery order is placed in the store. The store server 6 may perform the pop-up display 811 as soon as the registration is completed. According to such a configuration, it is possible to notify the store clerk of the order notification without interfering with work of the store clerk due to the pop-up of the order notification.

Here, the description of the flow of the processing will be continued with reference to FIG. 4 again.

When order reception registration (work start registration) is performed by, for example, an operation on the check button 815 of the pop-up display 811 or an operation of instructing a start of the picking work by the store clerk terminal 72 (ACT 9), the store server 6 requests the management server 5 for exhibition information and a stock record (ACT 10). In response to the request from the store server 6, the management server 5 outputs, to the store server 6, the exhibition information 523 and the stock record 524 related to a target store stored in the storage unit 52 (ACT 11).

The store server 6 generates data of picking information (picking data) based on the order data, the exhibition information 523 and the stock record 524 related to the host store (ACT 12). The store server 6 outputs the generated picking information to the management server 5 (ACT 13).

The management server 5 acquires and aggregates the picking information from each store, and updates the picking information 526 (ACT 14). Further, the management server 5 generates picking display information for displaying the picking information and outputs the picking display information to the store clerk terminal 72 (ACT 15).

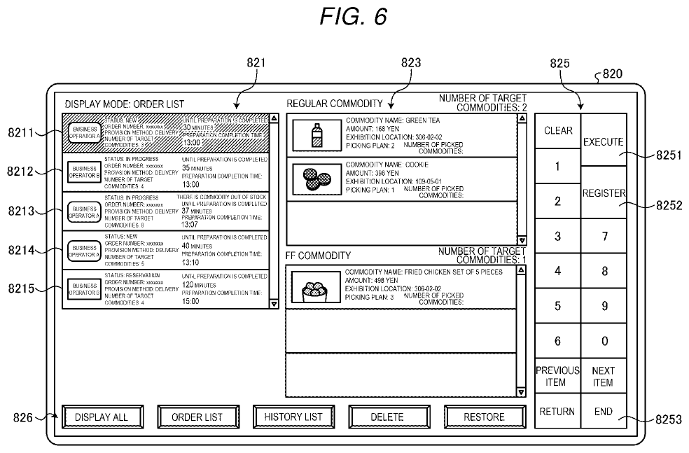

The store clerk terminal 72 displays picking screens (see FIGS. 6 and 7) including the picking information generated in the store server 6 on a display (not illustrated) (ACT 16). Here, a case where the picking screen is displayed on the store clerk terminal 72 is exemplified, but the present embodiment is not limited thereto. The picking screen may be displayed on any of the store server 6, the POS terminal 71, and the store clerk terminal 72. Further, the picking information may be presented by causing the printer 73 to issue a slip on which the picking information is printed.

Here, the picking work will be described with an example in which a tablet PC is used as the store clerk terminal 72 and a camera is mounted on the tablet PC.

The store clerk performs the picking work of the commodity for each delivery order while referring to the picking screens (see FIGS. 6 and 7) or the slip on which the picking information is printed. For example, the store clerk registers the picked commodity by scanning a label of the picked commodity with a camera (not illustrated) mounted on the POS terminal 71 or the store clerk terminal 72. For example, the store clerk registers the picked commodity by scanning the label of the picked commodity with an external scanner (not illustrated) connected to the store server 6, the POS terminal 71, or the store clerk terminal 72.

The store clerk terminal 72 outputs registration information indicating the commodity subjected to the picking registration to the management server 5 (ACT 17). The management server 5 aggregates a picking result (ACT 18) and outputs the picking result to the store server 6 (ACT 19). The store server 6 collates the picking result from the management server 5 with the order data (ACT 20), updates the picking information 626 according to a collation result, and outputs the collation result to the management server 5 (ACT 21). In the management server 5, the picking information 526 is updated according to the collation result. The picking screens (see FIGS. 6 and 7) of the store clerk terminal 72 are updated as the picking information 526 is updated. Thereafter, when all the commodities to be picked for each delivery order are subjected to the picking registration, the store clerk terminal 72 outputs a registration completion notification to the management server 5 (ACT 22). Registration completion may be determined in the management server 5, and the picking screens (see FIGS. 6 and 7) may be updated according to the registration completion notification output from the management server 5 to the store clerk terminal 72.

The management server 5 receives the registration completion notification from the store clerk terminal 72 and updates the stock record 524 (ACT 23). Further, the management server 5 outputs handling information based on the updated stock record 524 to the external management server 3 (ACT 24). The update of the stock record 524 will be described later.

The management server 5 receives the registration completion notification from the store clerk terminal 72 and outputs a picking result notification notifying that the picking is completed to the external management server 3 (ACT 25). For example, the external management server 3 receives the picking result notification from the management server 5 and updates a status display on a mobile terminal of a delivery staff of the delivery order or the customer terminal 2 of the customer.

In this way, in the order linkage system 1 according to the present embodiment, the picking registration can be performed by scanning the label such as a bar code of the picked commodity, and number registration can be performed. According to such a configuration, since a picking leakage can be detected, the picking leakage can be prevented.

FIG. 6 is a diagram illustrating an example of a screen 820 displayed in the processing of FIG. 4. The screen 820 of FIG. 6 illustrates the picking screen displayed on the store clerk terminal 72.

The screen 820 of FIG. 6 includes a display region 821 in which a list of a plurality of delivery orders 8211, 8212, 8213, 8214, and 8215 that are placed in the host store is displayed. In the display region 821 of FIG. 6, each of the delivery orders 8211, 8212, 8213, 8214, and 8215 includes displays of “status”, “order number”, “provision method”, “number of target commodities”, “time until preparation is completed”, and “preparation completion time”. In “status”, “new” is displayed to indicate a state in which none of the commodities is registered, “in progress” is displayed to indicate a state in which at least one commodity is registered but the registration is not completed, and “reservation” is displayed to indicate that subsequent picking work is scheduled. In “order number”, information for uniquely specifying the order data is displayed. In “provision method”, “delivery” is displayed to indicate that the delivery business operator delivers the commodity to the customer, or “delivering” is displayed to indicate that the customer visits the store and picks up the commodity. In “number of target commodities”, information indicating the number of commodities to be picked which are ordered in the delivery order is displayed. In “time until preparation is completed”, information such as a remaining time until a delivering time designated by the delivery business operator or a locker business operator is displayed. In “preparation completion time”, information such as the delivering time is displayed.

The screen 820 of FIG. 6 further includes a display region 823 in which information on the commodity of the delivery order selected in the display region 821 is displayed. In the display region 823 of FIG. 6, information is displayed such as a commodity name, an amount, an exhibition location, the number of the commodities to be picked, and the number of picking-registered commodities.

The screen 820 of FIG. 6 includes displays of operation units 825 and 826 for receiving user operations. For example, when “execute” button 8251 is operated in a state where any delivery order is selected in the display region 821, the store clerk terminal 72 displays a detailed display screen for the delivery order.

FIG. 7 is a diagram illustrating an example of a screen 830 displayed in the processing of FIG. 4. The screen 830 of FIG. 7 illustrates the detailed display screen when the delivery order 8211 is selected in the screen 820 of FIG. 6.

The screen 830 of FIG. 7 includes a display region 831 for order information on the delivery order 8211. The display region 831 of FIG. 7 includes displays of “order number”, “provision method”, “time until preparation is completed”, and “preparation completion time”.

Similarly to the screen 820 of FIG. 6, the screen 830 of FIG. 7 includes the display region 823.

Similarly to the screen 820 of FIG. 6, the screen 830 of FIG. 7 includes the display of the operation unit 825.

The screen 830 of FIG. 7 includes a display of the store layout image 833. The display of the store layout image 833 relates to a delivery order to be displayed, and displays a position of a commodity to be picked in the store with a map. The gondola number displayed in the store layout image 833 corresponds to the display of the exhibition information 523 indicating the exhibition location in the display region 823.

For example, in the store layout image 833, a position of the commodity to be picked, a position of the commodity selected in the display region 823, a position of the picked commodity, and a position of an un-exhibited commodity are displayed in an identifiable way. For example, in the display region 823, similar to the store layout image 833, a state of the commodity is displayed in an identifiable way.

In this way, in the order linkage system 1 according to the embodiment, the picking data is generated based on the order data, the exhibition information 523, and the stock record 524. The screens 820 and 830 including the picking information are displayed on the store clerk terminal 72. Specifically, the commodity information, the number, and the exhibition location of the commodity to be picked are displayed. According to such a configuration, the store clerk can more easily perform the picking work by picking up the commodity while referring to the screens 820 and 830.

In addition, in the store layout image 833, for example, an out-of-stock commodity such as a commodity that needs to be cooked in the store or a commodity that is not in stock at the store may be displayed in an identifiable way. Accordingly, it is possible to prevent the commodity that needs to be cooked in the store from being overlooked.

In addition, the display region 823 of the screen 830 of FIG. 7 further includes displays of a total number of planned picking and a current number of picked commodities. Accordingly, it is possible to prevent the picking leakage because it is easy for the store clerk to check the number of the picked commodities.

Here, the description of the flow of the processing will be continued with reference to FIG. 4 again.

When the picking registration is completed, the store server 6 generates the delivering information 627 (ACT 26) and outputs the generated delivering information 627 to the management server 5 (ACT 27). The store server 6 can detect the completion of the picking registration based on the collation result. The store server 6 may receive the registration completion notification from the store clerk terminal 72 or the management server 5, and may generate the delivering information 627 in response to the reception of the registration completion notification.

The management server 5 receives and aggregates the delivering information 627 from the store server 6 to update the delivering information 527 (ACT 28). Further, the management server 5 outputs delivering information notification for notifying the external management server 3 that the delivery order can be received based on the updated delivering information 527 (ACT 29). For example, the external management server 3 receives the delivering information notification from the management server 5, and updates a status display on the mobile terminal of the delivery staff of the delivery order or the customer terminal 2 of the customer.

When the picking registration is completed, the store server 6 outputs, to the printer 73, a slip to be attached to a commodity to be handed over (ACT 30). For example, the store clerk attaches the output slip to the picked commodity. For example, the store clerk hands over the commodity attached with the slip in the store to the delivery staff on a delivery business operator side. At a time of the hand-over, the store clerk scans or inputs the slip number printed on the slip and registers delivery completion.

In addition, when the picking registration is completed, the store server 6 automatically records the picking registration as store sales in the POS (ACT 31). Specifically, the store server 6 automatically records the picking registration by handling the picking registration in the same manner as the commodity registration in the POS terminal 71 for the commodity in the transaction of the customer who visits the store.

In this way, in the order linkage system 1 according to the embodiment, it is possible to automatically register sales when the picking is completed. Accordingly, sales registration work in the POS terminal 71 is unnecessary, and work related to the delivery order can be made efficient.

The store server 6 executes, by using the common commodity master 622, the sales registration based on the commodity registration by the POS terminal 71 and the sales registration based on picking registration. Meanwhile, the store server 6 can automatically perform the sales registration by adding fees according to whether the sales registration is based on the commodity registration by the POS terminal 71 or the picking registration. In a store such as a convenience store, the commodity stock is common between the store sales and the delivery order. Therefore, according to a configuration in which the common commodity master 622 is used, it is possible to implement a dual price system in which the price is different between the store sales and the delivery order while simplifying management.

The store server 6 may implement the dual price system by switching between a commodity master for store sales and a commodity master for the delivery order according to whether the sales registration is based on the commodity registration by the POS terminal 71 or the picking registration.

When store sales registration is performed due to sales at the store, the store server 6 outputs sales information for each transaction to the management server 5 (ACT 41). The sales information includes, for example, information of the commodity code (for example, JAN) and the number.

The management server 5 receives the sales information from the store server 6, and updates the stock record 524, for example, similar to a case of receiving the registration completion notification from the store clerk terminal 72 (ACT 42). Further, the management server 5 outputs the handling information based on the updated stock record 524 to the external management server 3 (ACT 43).

In this way, in the order linkage system 1 according to the embodiment, the stock record 524 is updated when the store sales registration is performed and the picking registration is completed. According to such a configuration, even when the common commodity stock is used between the delivery order and the store sales, it is possible to prevent the commodity from running out of stock due to the store sales after the delivery order.

When the stock record 524 is updated, the management server 5 or the store server 6 specifies a commodity whose number in the updated stock record 524 is less than the stock threshold as the commodity which is the output target of the out-of-stock information. Specifically, the management server 5 or the store server 6 sets the out-of-stock flag in the stock record 524 for the commodity whose number in the stock record 524 is less than the stock threshold. According to such a configuration, out-of-stock updating that is manually performed in the related art can be automated, and time and effort related to the out-of-stock update can be reduced. In addition, by providing a buffer by using a threshold for the out-of-stock update in consideration of a time lag of stock update, it is possible to prevent the commodity from running out of stock due to the store sales after the delivery order even when the common stock (store stock) is used between the delivery order and the store sales. Further, by setting the threshold for the buffer according to the update frequency, it is possible to prevent the commodity from running out of stock due to the store sales after the delivery order without excessive store stock.

A store to which the order linkage system 1 can be applied is not limited to a retail store such as a convenience store. The store to which the order linkage system 1 can be applied may be a store that can handle both an order of the commodity and a service from the customer terminal 2 of the customer and an order of the commodity and the service from the customer who visits the store and has the same commodity stock and the same service resource. In the embodiment described above, the term “commodity” is a general concept of a commodity and a service.

The delivery service business operator and the linkage service business operator may be the same business operator. In this case, the external management server 3 and the management server 5 are managed by the same business operator.

The linkage service business operator and the business operator (store) that operates the store may be the same business operator. In this case, the management server 5 and the store server 6 are managed by the same business operator.

The external service to which the order linkage system 1 can be applied is not limited to the delivery service. For example, the external service linked with the order management system 4 in the order linkage system 1 may be a locker service as described above with reference to FIG. 6.

For example, the locker service is a service that enables delivery of an article via a locker provided in a store, a station, an apartment where a customer lives, or the like.

For example, the management server 5 outputs the picking result notification (ACT 25) and the delivering information notification (ACT 29) to the external management server managed by a business operator that provides the locker service. In this case, for example, in the display region 821 of FIG. 6, for each of the delivery orders 8211, 8212, 8213, 8214, and 8215, in “provision method”, “locker” is displayed to indicate that a picked commodity is stored in the locker provided in the store or the like and delivered to the customer via the business operator. The delivering information notification may include an order number and a locker number for specifying a locker in which the store clerk stores the commodity.

For example, the external service linked with the order management system 4 in the order linkage system 1 may be a combination of two or more services such as a combination of the delivery service and the locker service. For example, there may be a mode in which the commodity of the delivery order delivered from the store clerk at the store is delivered to the locker managed by the locker business operator by the delivery staff of the delivery business operator. In this case, in the locker service, the delivery service, and the order management system 4, the delivering information such as an order number of an order and the locker number may be linked.

According to at least one embodiment described above, it is possible to reduce the overlooking of the delivery orders in the store.

Further, according to at least one embodiment described above, it is possible to improve efficiency of the work of the store clerk corresponding to the delivery order in the store.

In addition, according to at least one embodiment described above, it is possible to prevent a shortage of the commodity due to the store sales after the delivery order.

In the embodiment described above, “determining whether it is A” may be “determining that it is A”, “determining that it is not A”, or “determining whether or not it is A”.

Each control program executed by each device of the order linkage system 1 according to the present embodiment is provided by being incorporated in a storage medium in advance such as a ROM.

Each control program executed by each device of the order linkage system 1 according to the present embodiment may be provided by being recorded in a computer-readable recording medium such as a CD-ROM, a flexible disk (FD), a CD-R, or a digital versatile disk (DVD) as a file in an installable or executable format.

Each control program executed by each device of the order linkage system 1 according to the present embodiment may be stored in a computer connected to a network such as the Internet and provided by being downloaded via the network. Further, each control program executed by each device of the order linkage system 1 according to the present embodiment may be provided or distributed via a network such as the Internet.

The control program 521 executed by the management server 5 according to the present embodiment has a module configuration including the described above units (the input and output control unit 511, the information management unit 512, and the display control unit 513). The CPU of the control unit 51 reads the control program 521 from the storage medium and loads the described above units on a main storage device such as the RAM of the control unit 51. Accordingly, the units described above are generated on the main storage device.

The control program 621 executed by the store server 6 according to the present embodiment has a module configuration including the described above units (the input and output control unit 611, the information management unit 612, and the display control unit 613). The CPU of the control unit 61 reads the control program 621 from the storage medium and loads the units described above on a main storage device such as the RAM of the control unit 61. Accordingly, the units described above are generated on the main storage device.

While certain embodiments have been described, these embodiments have been presented by way of example only, and are not intended to limit the scope of the disclosure. Indeed, the novel embodiments described herein may be embodied in a variety of other forms; furthermore, various omissions, substitutions, and changes in the form of the embodiments described herein may be made without departing from the spirit of the disclosure. The accompanying embodiments and their equivalents are intended to cover such forms or modifications as would fall within the scope and spirit of the disclosure.

### Appendix

1-1

An information processing system includes:

a management server configured to receive order data including information for specifying an ordered commodity and a store from an external management server configured to aggregate an order from a customer who requests delivery of a commodity in stock at a store from the store;

a plurality of store servers provided in a plurality of stores, respectively, and each configured to communicate with the management server; and

a store terminal configured to communicate with any store server among the plurality of store servers, in which the management server transmits the received order data to a store server of the store specified by the order data among the plurality of store servers, and

each of the plurality of store servers receives registration of a commodity performed by the store terminal for each transaction in a host store, and notifies a user that a delivery order is placed in at least one of the store server and the store terminal when receiving the order data.

1-2

Notification to the user may include pop-up displaying order notification for notifying that a delivery order is placed in at least one of the store server and the store terminal.

1-3

The information processing system may further include a printer configured to communicate with the store server or the store terminal.

Notification to the user may include outputting, by the printer, a label on which order notification for notifying that a delivery order is placed is printed.

1-4

The notification to the user may include turning on an indicator in a predetermined region instead of the pop-up displaying when the store terminal is registering a commodity for each transaction in the host store or when the store terminal is registering a picked commodity for each piece of the order data.

1-5

An information processing apparatus includes:

an acquisition unit configured to acquire order data including information that is related to an order from a customer who requests delivery of a commodity in stock at a store from the store and is for specifying the ordered commodity;

an information management unit configured to receive registration of a commodity for each transaction in a host store and registration of a picked commodity for each piece of the order data; and

a display control unit configured to notify a user that a delivery order is placed when the order data is acquired, and to end the notification when the registration of the picked commodity for each piece of the order data is completed.

1-6

A program for causing a computer to

acquire order data including information that is related to an order from a customer who requests delivery of a commodity in stock at a store from the store and is for specifying the ordered commodity,

receive registration of a commodity for each transaction in a host store and registration of a picked commodity for each piece of the order data by using a common commodity master,

notify a user that a delivery order is placed when the order data is acquired, and

end the notification when the registration of the picked commodity for each piece of the order data is completed.

2-1

An information processing apparatus includes:

an acquisition unit configured to acquire order data including information that is related to an order from a customer who requests delivery of a commodity in stock at a store from the store and is for specifying the ordered commodity; and

a display control unit configured to generate, when the order data is acquired, picking data for displaying commodity information, the number, and an arrangement for a commodity to be picked for each piece of the order data based on the order data, exhibition information indicating the arrangement of the commodity in a host store, and a stock record indicating stock of the commodity in the host store.

2-2

The information processing apparatus may further include: an information management unit configured to receive registration of a commodity for each transaction in the host store and registration of a picked commodity for each piece of the order data by using a common commodity master, and to collate a registration result of the picked commodity for each piece of the order data with the picking data.

2-3

The information processing apparatus may further include: an output unit configured to output a slip to be attached to the commodity to be picked for each piece of the order data after the collation relating to picking for each piece of the order data is completed.

2-4

The information management unit may update the stock record based on the number of the picked commodities for each piece of the order data after the collation relating to the picking for each piece of the order data is completed.

2-5

The information management unit may automatically record store sales based on the registration result of the picked commodity for each piece of the order data after the collation relating to the picking for each piece of the order data is completed.

2-6

A program for causing a computer to

acquire order data including information that is related to an order from a customer who requests delivery of a commodity in stock at a store from the store and is for specifying the ordered commodity, and

generate, when the order data is acquired, picking data for displaying commodity information, the number, and an arrangement for a commodity to be picked for each piece of the order data based on the order data, exhibition information indicating the arrangement of the commodity in a host store, and a stock record indicating stock of the commodity in the host store.

3-1

An information processing apparatus includes:

an acquisition unit configured to acquire order data including information that is related to an order from a customer who requests delivery of a commodity in stock at a store from the store and is for specifying the ordered commodity;

an information management unit configured to receive registration of a commodity for each transaction in a host store and registration of a picked commodity for each piece of the order data by using a common commodity master, and update, based on a registration result of the commodity, a stock record indicating stock of the commodity in the host store; and

an output unit configured to output out-of-stock information that indicates a commodity handled as out of stock in the delivery order and is based on the stock record.

3-2

The information processing apparatus may further include a storage unit configured to store a stock threshold provided for each commodity.

The information management unit may specify, as a commodity which is an output target of the out-of-stock information, a commodity whose number in the stock record is less than the stock threshold.

3-3

The out-of-stock information may include a commodity code indicating the commodity whose number in the stock record is less than the stock threshold.

3-4

The information management unit may update the stock record at least when the registration of the commodity for each transaction at the host store is completed or when the registration of the picked commodity for each piece of the order data is completed.

3-5

The stock threshold may be set based on an update frequency of the stock record.

3-6

A program for causing a computer to

acquire order data including information that is related to an order from a customer who requests delivery of a commodity in stock at a store from the store and is for specifying the ordered commodity,

receive registration of a commodity for each transaction in a host store and registration of a picked commodity for each piece of the order data by using a common commodity master,

update, based on a registration result of the commodity, a stock record indicating stock of the commodity in the host store, and

output out-of-stock information that indicates a commodity handled as out of stock in the delivery order and is based on the stock record.

What is claimed is:

1. An information processing system, comprising:
a management server configured to receive order data including information for specifying an ordered commodity and a first store from an external management server configured to aggregate an order from a customer who requests delivery of a commodity in stock at a second store from the first store;
a plurality of store servers provided in a plurality of stores, respectively, and each configured to communicate with the management server; and
a store terminal configured to communicate with any store server among the plurality of store servers, wherein
the management server transmits the received order data to a store server of the store specified by the order data among the plurality of store servers, and
each of the plurality of store servers receives registration of a commodity performed by the store terminal for each transaction in a host store, and notifies a user that a delivery order is placed in at least one of the store server and the store terminal when receiving the order data.

2. The information processing system according to claim 1, wherein
notification to the user includes pop-up displaying order notification for notifying that a delivery order is placed in at least one of the store server and the store terminal.

3. The information processing system according to claim 1, further comprising:
a printer configured to communicate with the store server or the store terminal, wherein
notification to the user includes outputting, by the printer, a label on which order notification for notifying that a delivery order is placed is printed.

4. The information processing system according to claim 2, wherein
the notification to the user includes turning on an indicator in a predetermined region instead of the pop-up displaying when the store terminal is registering a commodity for each transaction in the host store or when the store terminal is registering a picked commodity for each piece of the order data.

5. The information processing system according to claim 1, wherein
the management server comprises a store master including a store name and a notification destination in association with a store ID.

6. The information processing system according to claim 1, wherein
the management server comprises exhibition information indicating a position of each commodity in each of the plurality of stores.

7. The information processing system according to claim 1, wherein
the management server comprises a stock record indicating stock of each commodity in each of the plurality of stores.

8. The information processing system according to claim 1, wherein
the management server transmits order information including a delivery number, a commodity code, a number of commodities, and a unit price.

9. An information processing apparatus, comprising:
an acquisition component configured to acquire order data including information that is related to an order from a customer who requests delivery of a commodity in stock at a store from the store and is for specifying the ordered commodity;
an information management component configured to receive registration of a commodity for each transaction in a host store and registration of a picked commodity for each piece of the order data; and
a display controller configured to notify a user that a delivery order is placed when the order data is acquired, and to end the notification when the registration of the picked commodity for each piece of the order data is completed.

10. The information processing apparatus according to claim 9, wherein
notification to the user includes pop-up displaying order notification for notifying that a delivery order is placed in a store terminal.

11. The information processing apparatus according to claim 9, further comprising:
a printer configured to communicate with a store terminal, wherein
notification to the user includes outputting, by the printer, a label on which order notification for notifying that a delivery order is placed is printed.

12. The information processing apparatus according to claim 10, wherein
the notification to the user includes turning on an indicator in a predetermined region instead of the pop-up displaying when the store terminal is registering a commodity for each transaction in the host store or when the store terminal is registering a picked commodity for each piece of the order data.

13. The information processing apparatus according to claim 9, wherein
order data comprises at least one of a delivery number, a commodity code, a number of commodities, and a unit price.

14. An information processing method, comprising:
acquiring order data including information that is related to an order from a customer who requests delivery of a commodity in stock at a store from the store and is for specifying the ordered commodity;
receiving registration of a commodity for each transaction in a host store and registration of a picked commodity for each piece of the order data by using a common commodity master;
notifying a user that a delivery order is placed when the order data is acquired; and
ending the notification when the registration of the picked commodity for each piece of the order data is completed.

15. The information processing method according to claim 14, wherein
notification to the user includes pop-up displaying order notification for notifying that a delivery order is placed in a store terminal.

16. The information processing method according to claim 14, further comprising:
communicating with a store terminal via a printer; and
outputting, by the printer, a label on which order notification for notifying that a delivery order is placed is printed.

17. The information processing method according to claim 15, further comprising:
turning on an indicator in a predetermined region instead of the pop-up displaying when the store terminal is registering a commodity for each transaction in the host store or when the store terminal is registering a picked commodity for each piece of the order data.

18. The information processing method according to claim 14, wherein
order data comprises at least one of a delivery number, a commodity code, a number of commodities, and a unit price.
